(19) United States
(12) Patent Application Publication
(10) Pub. No.: US 2010/0169378 A1
(43) Pub. Date: Jul. 1, 2010

(54) ACCESS MANAGEMENT SYSTEM

(75) Inventors: Richard John Tinberg, New South Wales (AU); Jo-Ann Elizabeth Pass, New South Wales (AU)

Correspondence Address: Joseph Bain;Novak Druce & Quigg LLP, 525 Okeechobee Blvd, Suite 1500, West Palm Beach, FL, 33401, US

(73) Assignee: VALOREM SYSTEMS PTY LIMITED, Gordon (AU)

(21) Appl. No.: 12/441,535

(22) PCT Filed: Sep. 18, 2007
(86) PCT No.: PCT/AU2007/001377

§ 371 Date: Feb. 1, 2010

(30) Foreign Application Priority Data
Sep. 18, 2006 (AU) 2006905140
Dec. 12, 2006 (AU) 2006252035

(51) Int. Cl. G06F 17/30; H04L 9/32

(52) U.S. Cl. 707/781; 726/5; 707/E17.032

(57) ABSTRACT

A system and method for monitoring access in respect of a number site including means for identifying an individual requesting access to a particular site, using for example, a card reader and/or a biometric scanner. Once the individual has been identified, a computer program and database for determining what access conditions must be satisfied before the individual is allowed access to the site. If the computer program determines that one or more access conditions are not satisfied, the individual is provided with information via a user interface so as to satisfy those access conditions that were lacking. Access to the site is allowed once the individual has acknowledged that they have understood the information provided and the access conditions have been satisfied.

### CROSS REFERENCE TO RELATED APPLICATION

This application is the entry into the United States National Stage of PCT Application Number PCT/AU2007/001377 filed Sep. 18, 2007 and claims priority from Australian Application No. 2006905140 filed Sep. 18, 2006 and Australian Application No. 2006252035 filed Dec. 12, 2006.

### BACKGROUND OF INVENTION

1. Technical Field

The present invention relates to the management of buildings and facilities, and managing access in respect of such sites using an automated computer system.

2. Background Art

Organisations of all sizes and in all industries require a means to monitor access to their premises by persons. For example, businesses require a means to monitor access to their premises by contractors, such as regular maintenance workers attending heating, ventilation, and air conditioning systems, lifts, plant and equipment, and also security, cleaning, labour hire and other regular contractors. Site access may also be required by others, for example safety inspectors or regulators, customers and sales representatives.

At present, medium to large businesses usually manage such visitors by using paper-carbon copy based systems. Such systems may simply rely on visitors to record their own details before entry and note the time of exit, or may involve one or more staff members overseeing access to the premises.

These systems may also include messages/statements about confidentiality, security, and occupational health and safety (OH&S) to which a visitor must agree before entering the premises. In completing their details and signing the paper, the individual visitor acknowledges that they understand and agree to the messages/statements but there is no real verification that they have understood the information provided.

A further limitation of paper systems is that they do not verify, for example, whether a contractor company has the requisite insurance cover to carry out an inspection or commence work on a site, and whether this insurance cover is up-to-date. Similarly, it is not verified whether contractors engaged in higher risk activities such as hot works or works in confined spaces, have accurately and thoroughly completed a risk assessment for these activities prior to accessing the site and commencing work.

Additionally a limitation of paper systems is that they are cumbersome and inefficient in providing information about who has visited a site and what they did during that visit. For example a contractor company may have a contract to provide 400 hours of work during one calendar month and to verify if they contract has been met the paper based information has to be collated and manually added to determine the number of hours that have been provided by the contractor company.

These issues become especially complex when many parties share a single site, such as a shopping mall or office building. Access may be required only to public areas, to restricted areas within the building infrastructure, or to one or more individual tenants. Apart from building access controls, each tenant may have specific requirements for contractors within their part of the building. In order to manage this, typically many different paper based systems are used, and in many cases the records are not effectively checked or managed to provide effective records or controls on access.

It is an object of the present invention to provide an electronic system for managing access to a site so that relevant information can be provided to and obtained from persons requiring access in an efficient way as part of the access procedure.

### SUMMARY OF THE INVENTION

Broadly, in one aspect the present invention provides a method and system for managing access to a site, wherein it is determined whether site, functional and individual requirements are satisfied before an individual accesses a site. In a preferred form, the system enables information to be provided to the individual and received from the individual. In particular, this may include an acknowledgement that they have understood the information provided. The relevant information may be about currency of insurance cover, safety training, current authorisations, site induction, or any other matter relevant to granting access. This information is in turn available electronically for reporting. This arrangement accordingly facilitates the keeping of records which indicate, for example, that appropriate information was provided at particular times to particular individuals and acknowledged as understood. This allows for practical and legal requirements to be met in an auditable and verifiable fashion.

In another broad aspect, the present invention provides a method and system for managing access to one or more sites, wherein a specific access profile is provided for each individual for each site, and a database is created including the access conditions and details of access for each site. When an individual is present for access to a site, profiles relevant to many levels of rules can be applied to manage access and the information provided to that person. For example, an individual may be presented with information relevant to them as an individual, to the specific site they are accessing, to the specific part of the site they are required to visit, and/or to their specific organisation and function. Some of the conditions may apply across many sites, or many individuals across one or more sites. Further information may be provided depending, for example, upon the responses provided to enquiries made automatically during the access process.

The database in turn can compile details of those who have accessed certain sites and when, linked to the various profiles and individuals within the system.

Such a database in turn facilitates reporting at many levels and with separate access. In specific implementations, for example, the facility manager for a site may have access to reporting about all contractors present on a site, a specific store owner may have access to details of all contractors present across their stores located on different sites, or a specific contractor can determine the current logged locations of all their employees on a site, or on many sites. It will be appreciated that such reports, and indeed other parts of the system, may be accessed and configured remotely from the site, for example in the case of a contractor requiring information on all their employees across many sites. Further, access and communications can be controlled on different bases by rules imposed at different levels, so as to effectively implement policies and procedures across many sites and for many different types and levels of individuals.

An advantage of certain implementations of the invention is that entrants to a site may be automatically made aware, for example, of the safety procedures associated with any site risks and undergo relevant instruction as part of the access procedure before entering a site. Other requirements, such as adequate insurance cover can also be verified before the individual accesses the site. A further advantage of such an implementation is that should the individual require safety training, for example, this training can be provided on the spot so that not only are the OH&S requirements met but the information is acknowledged and retained by the visitor whilst onsite. A further advantage of such implementations is that as all activity is being electronically tracked it can be used to produce reports about the activity on a particular site, individual or collectively across distributed geographical locations so as to enable a company to have access to real time information about site activities.

It should be understood that the concept of a site is intended to be interpreted broadly. It may mean one physical site, or some part of that site. It may be a virtual site, for example including different physically separated components, or some area or set of areas within a physical site. It may relate to different floors or areas within a single building, or to a large number of related buildings. It may be defined for the purposes of the present invention in any way which is useful to the systems users to facilitate access and related reporting.

According to one aspect, the present invention provides a system for managing access in respect of one of more sites, the system including:

identification means for identifying an individual requesting access to the site whereby access to the site is allowed only when one or more access conditions are satisfied;

computer program and database for determining whether the access condition is satisfied by the individual;

a user interface for providing information to the individual and for allowing the individual to enter an acknowledgment that the information has been understood;

wherein entry of the acknowledgement is taken to satisfy, at least in part, the access condition.

According to another aspect, the present invention provides a system for managing access in respect of a plurality of sites, the system including:

identification means for identifying an individual requesting access to a site selected from the plurality of sites whereby access to the site is allowed only when one or more access conditions are satisfied;

computer program and database for determining the access condition based on the site and the identity of the individual, and whether the access condition is satisfied by the individual;

a user interface for providing information to the individual if the access condition is unsatisfied, the information pertaining to the unsatisfied access condition, and for allowing the individual to enter an acknowledgment that the information has been understood;

wherein entry of the acknowledgement is taken to satisfy, at least in part, the unsatisfied access condition.

According to yet another aspect, the present invention provides a method for managing access in respect of a plurality of sites, including the steps of:

A) identifying an individual requesting access to a site selected from the plurality of sites, the site having one or more access conditions;

B) accessing a database to determine one whether the access condition is satisfied by the individual;

D) providing information to the individual via a user interface;

E) receiving an acknowledgement from the individual that the information has been understood wherein the acknowledgement is taken to satisfy, at least in part, the unsatisfied access condition; and

F) allowing access to the site only when the access condition is satisfied.

According to yet another aspect, the present invention provides a method for managing access in respect of a plurality of sites, including the steps of:

A) identifying an individual requesting access to a site selected from the plurality of sites;

B) determining one or more access conditions for the site based on the site and the identity of the individual;

C) accessing a database to determine whether the access condition is satisfied by the individual;

D) if the access condition is unsatisfied, providing information to the individual via a user interface, the information pertaining to the unsatisfied access condition;

E) receiving an acknowledgement from the individual that the information has been understood wherein the acknowledgement is taken to satisfy, at least in part, the unsatisfied access condition; and

F) allowing access to the site only when the access condition is satisfied.

The individuals may be contractors, employees, visitors or any other person requiring access to the site for a certain period of time.

It will be apparent that an advantage of some implementations of the present invention is that the information provided to the individual at the time of entry to the site is both pertinent and timely. Such information may be provided in the form of text, images, audio and/or video which the visitor may review and subsequently acknowledge that they have understood.

In a preferred implementation, the server application and core database are hosted by a central server and the client application and remote database reside on remote computer systems, which allows access to the server application by numerous remote computer systems, which may be located at a single site or across multiple sites, as long as such computer systems are able to establish and maintain communication with the server. Such communication may be in the form of a constant connection or involve periodic connections between the computer systems and server for a suitable period of time. It will be appreciated that the application and/or associated databases may also be mirrored across a number of servers for load sharing purposes.

In a distributed implementation, the applications and/or associated databases may be hosted on a number of computer systems with appropriate connections existing between these systems to synchronise data. These computer systems may be located at a single site or across multiple sites.

In any of these implementations, the applications and/or databases may be accessed remotely by third parties such as contractor companies who are not located at any one of the sites. In this case, third parties are able remotely access the server application using a suitable computer system in order to, for example, distribute messages to individuals accessing sites, configure access conditions which apply and/or generate relevant reports.

It will be apparent that another advantage of the present invention is that the application is accessible simultaneously and remotely by a number of users over a number of sites.

The site display device allowing an individual to interact with the application is preferably a touch screen panel with built-in speakers. However, the present invention is not limited to any particular implementation or hardware system. It could be implemented using a non-touch screen display monitor or panel, and a keyboard and mouse to allow individuals to interact with the application.

Preferably, the individual to the site is identified initially by scanning of a security card and/or a biometric identifier such as fingerprint. The individual may also confirm their identity by entering a preselected password. Any suitable identification method can be used, consistent with the security requirements at the site.

To enable access for configuration of site information the application is preferably accessed by a standard PC with an internet browser via a URL link. However, the present invention is not limited to any particular hardware system or configuration.

### BRIEF DESCRIPTION OF THE DRAWINGS

Preferred and alternative embodiments of the present invention will be described with reference to the accompanying drawings, in which:

FIG. 1 is a conceptual diagram illustrating the overall physical and logical arrangement of a preferred implementation of the present invention;

FIG. 2 is a flow chart illustrating the general process of managing access to a site by an individual; and

FIG. 3 is a flow chart illustrating the web based configuration, administrative and reporting process.

### DETAILED DESCRIPTION

The present invention will be described with reference to particular implementations. These are intended to better explain implementations of the present invention, and are not intended to be limitative. It will be appreciated that the present invention is not limited to any particular operating systems or proprietary devices. Rather, the invention is at a more functional level. It should further be appreciated that the present invention can readily have further features added to it as the functionality of computer systems, and the costs thereof, change over time. All such additions and modifications fall within the scope of the present invention.

Furthermore, it is noted that the examples described below may need to be altered in detail or in substance, depending upon the specific capabilities and/or operating system of the particular computer system used.

### Physical Setup

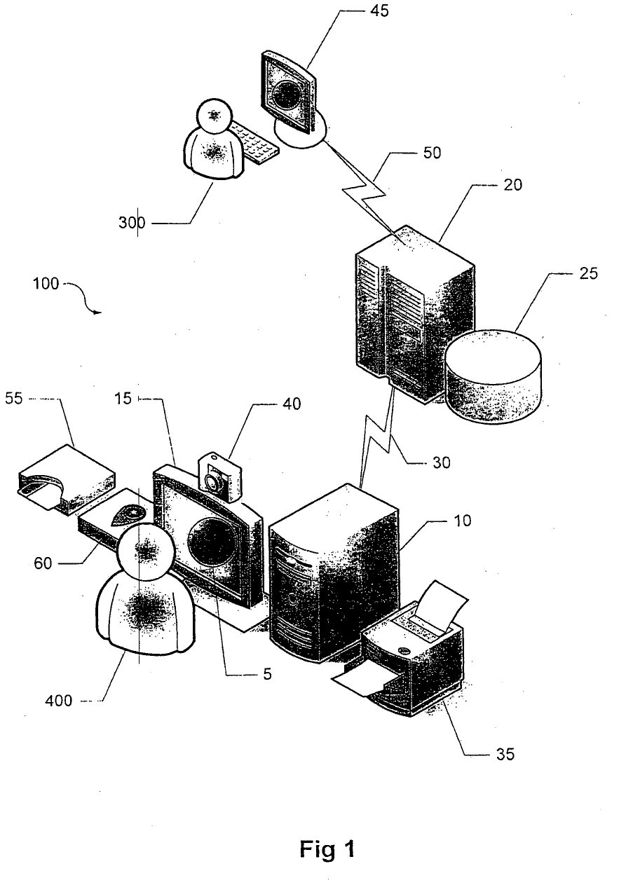

FIG. 1 is a composite conceptual drawing illustrating both hardware and logical descriptions of the system 100. The system 100 is specifically configured for each particular site and the interface components are typically located at an entry/exit point, or at some other suitable location, of that site. The system 100 is suited to any site which requires access by individuals such as employees and visitors, to be monitored. Examples of such sites include office buildings, warehouses, manufacturing facilities, trade shows, conferences, events, clubs and schools.

It should be understood that the concept of a site is intended to be interpreted broadly. It may mean one physical site, or some part of that site. It may be a virtual site, for example including different physically separated components, or some area or set of areas within a physical site. It may relate to different floors or areas within a single building, or to a number of related buildings. It may be defined for the purposes of the present invention in any way which is useful to the system users to facilitate access and related reporting on site activity.

Further, the nature of individuals who may be required to use the system is flexible, according to the requirements of the site. For example, some sites may require that all persons who access the site are processed by the system, as access is generally restricted. Other sites may require that only certain classes of visitors or contractors use the system, for example in a site with extensive public access. These classes may vary between different sites within a commonly administered system.

The system 100 includes client application 5 and remote database 80, server application 20 and core database 25 are hosted and accessible via a personal computer 10 and personal computer 45. Preferably, the server application 20 is a web application developed in a suitable web enabled programming language such as Java, .Net or ASP. The server would in most instances control multiple sites, and allow for the imposition of layered rules for different sites and individuals. The personal computer 10 is preferably connected to a touch screen 15 which provides an individual 200 with an interface to the system 100, and a printer 35 and camera 40 to allow identification badges and permits to be prepared.

The client application 5 and remote database 80 preferably provides the following functionality:
Site and individual specific interface screens
Password based user log on and off
Seamless connection with the server application 20 and core database 25
Recording and time stamp of all user activity
Printing of identification badges, permits and reports
Help
Seamless synchronisation to server application 20 and core database 25

In another implementation, the personal computer 10 may be connected to a regular, ie non-touch screen, display monitor, and be provided with a keyboard and/or mouse to allow interaction with system 100.

It is also envisioned that any one site may have more than one entry/exit point or suitable locations, and therefore any number of such setups may be installed at each site.

User identification may occur using any suitable means, with appropriate regard for the security requirements and the specific objectives of the system administrator and site management. For example, a simple selection of name on a touch screen, or card swipe, and entry of password or identification number on a keypad or keyboard may be adequate for many applications, where the main purpose is to confirm attendance and communicate requirements, and high level access security is not required. Biometric devices, for example fingerprints; secure devices such as tokens or smartcards, and the like may be included as required. Such measures are well understood and can be readily obtained commercially, and their details do not form part of the present invention.

If desired, access to the site may be controlled without the need for additional security personnel, by the provision of entry/exit doors, turnstiles, gates, etc which are electronically connected to the system 100 so that when a individual 200 is allowed access to the site, the relevant point of entry is opened to provide access to the site. Similar arrangements can log exit from the site.

The system 100 according to the present embodiment is connected to the server application 20 and core database 25 via an IP to IP connection 30, or alternatively a virtual private network (VPN) connection through the Internet, or any other equivalent connection means. However, it will be appreciated that any suitable communication arrangements can be used.

The administrator 300 may also access the server application 20, for example, by using a personal computer 45 connected to the server application 20 via a URL connection 50. It will be appreciated that any number of other authorised users, such as site supervisors, management, etc may access the server application 20 in similar manner and that such users may be located a site or at any other location.

Preferably, each user that accesses server application 20 has their own individual and unique user id that enables access to their specific security profile.

Core Database 25, which typically resides on server 65, stores information from, and relays information to, client application 5 on one or more sites so as to provide a central data repository for server application 20.

Differing levels of access to the server application 20 are usually provided to different users so as to allow, for example, the site controller, who may be a site owner or facilities manager, access to all the data while an operator at a contractor company providing services to the site, may only have access to limited data and more specifically to the data relating only to their company and its employee and sub-contractors. Suitable levels of access may also be provided to site supervisors, employees of the organisation, contractors and other visitors.

Similarly, the server application 20 typically alters the information and controls available on a screen depending on the authorisation level of the user, so as to appropriately limit the functionality and access to data a particular user has. A normal employee or contractor will only generally only have access to basic information. Furthermore, the system 100 options, interface screens and rules are completely customisable by the administrator 300, and are generally set at a global level so that they apply uniformly across a particular site or multiple sites via synchronisation with client application 5. It will be appreciated, however, that whilst the system 100 is preferably customisable, the present invention could be implemented in a way which is less customised. For example, a generic solution could be provided for a particular industry, for which only a more limited degree of customisation is provided.

The system 100 also provides for the application of one or more rules that to a single site or across a number of sites. Such rules may determine, for example, which individuals may access a site, what requirements are to be met before visitors access particular sites, information which must be provided to visitors to these sites, information that must be collected by visitors to these sites, etc. Typically such rules will be implemented in a layered fashion so that, for example, a global rule applies across all relevant sites and particular rules apply to all industrial sites within this group. A specific site with particular safety issues may have a specific preconfigured rule applicable to that site only.

The layering concept also applies to the communication function and to different classes of employees or contractors. For example, the system 100 may be applied across a series of buildings, owned by multiple owners, with a common elevator contractor. The elevator contractor may be provided with access to send a communication to all their employees across the various sites, which is not viewed by other individuals accessing those sites. However, at each site, the specific requirements for each building, for example site training, can be applied to the elevator contractor's employees, independently from the elevator contractor's control. This layering, when implemented, provides a powerful communication and reporting tool for the users of the system 100, administrators, and the organisations concerned.

These rules may be created, modified or deleted by users of the system 100 who have been given access to make such changes via server application 20, and who may be located at a site or any other location.

### Logon Process

The following description is intended to describe the operating procedures for a specific implementation of the present invention. It will be appreciated that as the client application 5 can be highly customised by administrator 300 via server application 20, it is to be understood that many and varied implementations are possible.

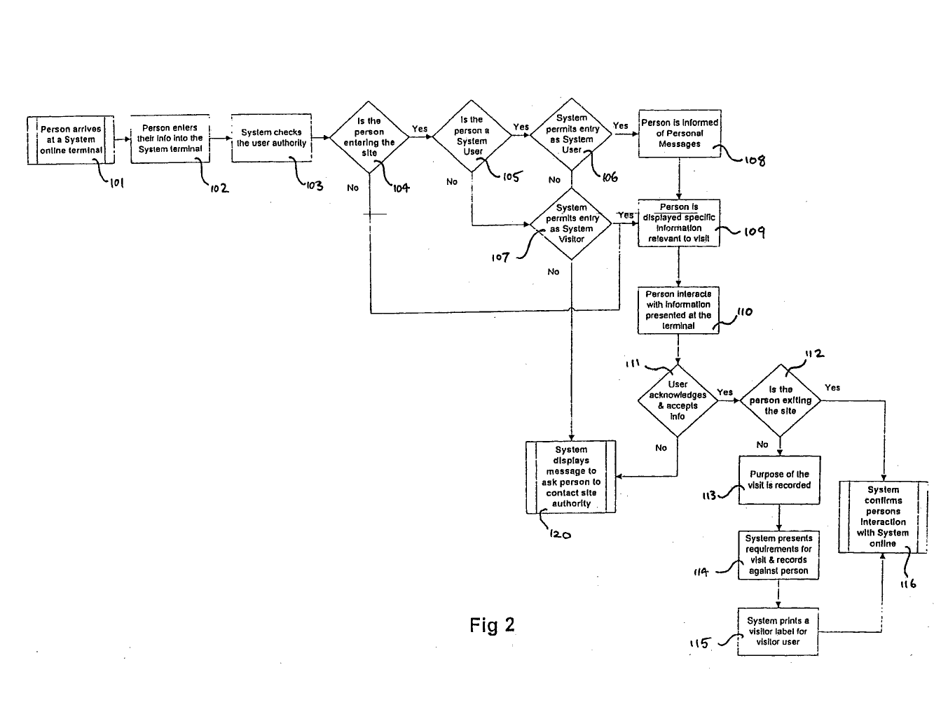

In a typical scenario, illustrated in FIG. 2, an individual 200 attends the site (step 101) and is greeted at the point of entry by the system 100. The individual 200 logs on to the client software (step 102) by entering their details, such as their name and/or the name of the business they represent. The individual 200 may also enter the details of their visit to the site or selects from a list of available options. If a more secure setup is required, the system 100 may include a card reader 55 to allow such details to be extracted simply by the scanning or swiping of a previously issued magnetic identification card, or a biometric scanner 60 to determine the identification of the individual 200 based on previously recorded fingerprint details, for example, or any combination of the above. The client application 5 accesses (step 103) core database 25 to determine the identity of the individual 200 and the level of access that individual 200 has to the system 100. Once the individuals 200 identity and level of access is determined, the individual 200 confirms (step 104) whether or not they are entering the site.

In the situation where the individual 200 is, for example, a courier delivering a package to the site and does not actually require entry to the site, the system 100 may simply record details (step 110) such as the time of the individuals 200 visit to the site, without prompting for any further information or providing any further information to the individual 200.

Should the individual 200, however, require entry to the site, the client application 5 determines 105 whether the individual 200 is a registered user of the system 100. If the individual 200 is not a registered user, they are typically permitted entry to the site as a temporary site visitor 107 or are directed to contact the site authority 120. It will be appreciated that temporary site visitors are typically provided with a unique identifier for the duration of their visit to the site.

If the individual 200 is a registered user at step 106, then the client application 5 determines at this time whether the individual 200 is able to access the site by verifying for example, that they have previously been inducted to the site and undergone relevant training, that they have adequate insurance cover and insurance certificates have been lodged with the site controller (owner or facility manage), and/or that they have completed any other site specific requirements such as police checks, etc. The system may also display personal and company messages (step 108) in the form of text, pictures, audio and/or video that have been previously left in the system 100 for the individual 200 by a site supervisor or administrator 300, for example. It will be appreciated that such messages may be simultaneously sent to a number of system users at a particular site or a number of system users across a number of sites.

The client application 5, based on preconfigured rules set up for the particular site by an administrator 300, also provides specific information 109 to the individual 200. Such information may take a number of forms such as reminders about the date insurance is due to be renewed, a site induction video or a step-by-step risk assessment. Once the individual 200 has reviewed this information and acknowledged their understanding of this information (step 110), he or she accesses the site as required. At this point, the status of the individual 200 is changed to ‘IN’ in by the client application 5 and information is written to the remote database 80 and time stamped with the time of entry to the site and then synchronised with server application 20 and core database 25. The client application 5 subsequently returns to a log on screen allowing other such individuals to be processed.

In certain implementations, the client application 5 may also produce an identification badge using a printer 35 for the individual 200 to display while they are on site.

It is important to note that if client application 5 and remote database 80 do not have an active IP to IP connection 30 to synchronise to server application 20 and core database 25 the data entered by individual 200 is held in client application 5 and remote database 80 until an active IP to IP connection 30 is established. In another implementation, remote database 80 and core database 25 may be parts of the same distributed database.

### Logoff Process

The process by which the individual 200 logs off the system 100 is as follows. Once the individual 200 is finished at the site, he or she returns to the touch screen 15 or a different screen at another point of exit and selects the log off option in the client application 5. The individual 200 again enters their name and/or the name of the business they represent, or scans their card, etc. After confirming the details of the individual 200 stored in the client application 5 and remote database 80 are correct, further information as required and determined by the client application 5 is provided to the individual 200. Once the individual 200 has acknowledged receipt and understanding of this information they may be prompted by the client application 5 for further information. Once the client application 5 has determined that the individual 200 may exit the site, the individual 200 hands in or discards the printed visitor badge and the status of the individual 200 is changed to ‘OUT’ in client application 5 and remote database 80 and then synchronised to server application 20 and core database 25 and the time of exit from the site is logged.

### Specific Examples

Particular examples of the operating procedures of the system 100 are outlined below.

In the first example, the individual 200 is a contractor who has arrived at the site to undertake specific risky activities, such as hot works, confined spaces, height work, machinery maintenance, etc. Once the contractor 200 has swiped his or her security card in card reader 55 and entered the relevant password on the log on screen in the client application 5, the client application 5 and remote database 80 accesses the server application 20 and core database 25 to determine, for example, the level of access the contractor 200 has, details of the contractor company's insurance cover, contract details, induction details, etc.

If the system 100 determines that the contractor 200 is not able to access a site based on a reason which cannot be immediately rectified, such as the insurance of the contracting company has expired or the contractor 200 is not covered by the insurance contract, the contractor 200 is informed of this fact and directed to contact the contractor company and/or site authority. In this situation, the client application 5 does not log the contractor 200 into the site, but instead returns to the logon screen.

If it is determined, however, that the contractor 200 may be granted access to the site, the client application 5 proceeds with the process. In certain situations, personal and company messages in the form of text, pictures, audio and/or video may have been previously left in the system 100 for the contractor 200 by a site supervisor, for example, and these messages are provided to the contractor 200 at this time. The client application 5 may also determine that the contractor 200 is required to review site specific messages at this time in relation to matters such as evacuation procedures, etc. Once the contractor 200 has reviewed and acknowledged these messages, the contractor 200 is prompted by the client application 5 to indicate the reason for their visit to the site. The contractor 200 may select from a list of contract work for the site, a specific work order which needs to be actioned or enter the details of the reason for their visit. The client application 5 logs this selection or the data entered in the remote database 80 and synchronised to server application 20 and core database 25 and determines whether any information is required to be provided to the contractor 200 before access he or she accesses the site.

The contractor 200, upon completion of the site work, approaches a display screen 15 at an entry/exit point of the site. The contractor 200 swipes a security card in card reader 55 and enters the relevant password on a screen, similar to the manner in which the contractor 200 logged onto the system 100. The client application 5 and remote database 80 determines the identity of contractor 200 and accesses the relevant details in server application 20 and core database 25. If there are any personal messages for the contractor 200 at this time, they are displayed by the client application 5. Similarly, if site specific messages are required to be presented to the contractor 200 at this stage, they are displayed to the contractor 200 who must review and acknowledge these messages before being allowed to exit the site.

The client application 5 typically displays a list of the work orders selected by the contractor 200 before entering the site. The contractor 200 confirms whether each work order has been completed and may include additional comments if required. If a work order has not been completed, the contractor 200 may change the status of the work order to, for example, further review required, and add appropriate comments. Once the client application 5 has determined that the contractor 200 is allowed to exit the site, the status of the contractor 200 is changed to ‘OUT’ in remote database 80 and synchronised to server application 20 and core database 25 and the time of exit logged.

A further example is the situation where the individual 200 is an employee returning to work after an injury. In this scenario, it would be determined by the client application 5 that the employee 200 requires information reminding him or her about safe work practices and then directing the employee 200 to only undertake light duties while they are onsite. The system 100 may also allow employees to sign in for work and subsequently direct them to specific tasks to be completed during their time onsite or remind them of training which is due, such as the renewal of a first aid certificate. Messages from supervisors may also be relayed to employees at this point which is especially important in shift work and sites that run 24/7.

It will be appreciated that the precise sequence and nature of messages and requests may be varied as desired at the specific site, and in accordance with the systems of the various stakeholders and systems users. The structure of the system is such as to provide extensive flexibility in imposing rules and procedures, and any effective implementation will require considerable attention to the requirements of the specific site.

### Reporting

The server application 20 also allows, as illustrated in FIG. 4, tracking and reporting on some, if not all, of the above described activity, some examples of which include messages sent and received, acknowledgments, site activity by visitors, contractors and employees, the amount of hours a particular individual 200 has spent on site as determined by their logged entry and exit time or the amount of hours spent on site by representatives of a particular contractor company.

An area of particular advantage according to this implementation of the present invention is that multiple layers of rules and access can be superimposed, and can be reported in the same way. This can be done on an historical or real time basis.

It is envisioned that security access and data partitions are determined by server application 20 in the core database 25 to control access to the information and allow each user to access the data relevant to them, and to view and print preset reports based on their requirements. They are also able to create custom reports based on information accessible. For example:
Individual employees can access reports about training, messages or reminders they have received, etc
Contractor Companies can access reports about the movements of their employees on specific sites, or across a number of sites
Site supervisors can access reports about all activity on their site, or across a number of sites, including details of visitors (current or those from specific time periods), contractor companies, and a summary of hours spent onsite by a particular visitor or representatives of a particular contractor company.

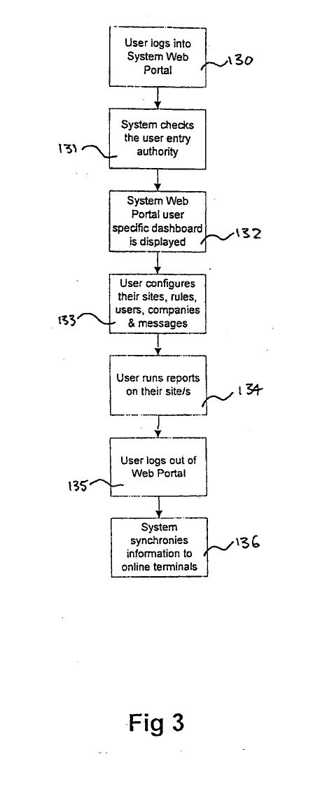

In order to access relevant reports, a user is required to access the system 100 via a web portal (internet/intranet interface). Typically, the web portal may be accessed via any suitable browser application using a personal computer 45 which may or may not be located a site. This is explained further with reference to FIG. 3. A user logs onto (step 130) the web portal via URL connection 50 using a login id and password. It will be appreciated that additional or alternative security measures, such as the use of a number generating security device, may also be employed. The system checks that the user has the appropriate authority to proceed. It will be understood that although a user is allowed to log on, their access will vary. A user specific dashboard (step 132) is displayed to each user after logon, to provide an interface to their permitted areas. The user may then proceed (step 133) to configure their permitted sites, rules, users, and companies. They may also generate messages as required. The user may then also run reports (step 134). When the session is completed, the user logs out (step 135) and the system synchronises to the online terminals (step 136). However, during the session it is preferable that continual synchronisation occurs.

It will be appreciated that such reports can be utilised a number of contexts including:
the production of timesheets for payroll of contractors, especially in relation to cleaning and security personnel,
verification of contract adherence for contractors, ie by determining the hours, period of attendance etc
determining personnel on site, and their likely location, for evacuation and emergency purposes

It will be appreciated that the present invention may be implemented on a variety of platforms, with additions and variations enabled by the device chosen, and the application required.

Any discussion of the documents, acts or knowledge in this specification is included to explain the context of the invention. It should not be taken as an admission that any of the material forms part of the prior art base or the common general knowledge in the relevant art.

What is claimed:

1. A system for managing access in respect of one of more sites, the system including:
identification means for identifying an individual requesting access to the site whereby access to the site is allowed only when one or more access conditions are satisfied;
computer program and database for determining whether the access condition is satisfied by the individual;
a user interface for providing information to the individual and for allowing the individual to enter an acknowledgment that the information has been understood;
wherein entry of the acknowledgement is taken to satisfy, at least in part, the access condition.

2. A system according to claim 1, wherein at least one of the access condition or the information relate to occupational health and safety.

3. A system according to claim 1, wherein the individual is allocated by the computer program to one or more groupings of individuals in the database, and the access condition is also determined based on the grouping of individuals to which the individual is allocated.

4. A system according to claim 1, wherein the user interface provides further information to the individual, the further information relating to at least one of the site, the individual or the grouping of individuals to which the individual is allocated.

5. A system according to claim 1, wherein the identification means comprises at least one or more of a security card scanner, biometric scanner, and password.

6. A system according to claim 1, wherein the user interface comprises a touch screen.

7. A system according to claim 1, wherein the system is able to be accessed and configured from any one or more of the plurality of sites.

8. A system according to claim 1, wherein the user interface allows the individual to confirm exit from the site.

9. A system according to claim 1, wherein the computer program determines details of site activity comprising at least one of the number of times the individual has accessed the site or the amount of time the individual has accessed the site for, and the database stores the details of the site activity.

10. A system according to claim 9, wherein the system comprises reporting means for generating reports relating to the site activity of one or more sites.

11. A system according to claim 10, wherein the reports relate to an individual, one or more groupings of individuals, or any combination thereof.

12. A system according to claim 10, wherein the reports relate to one or more selected time periods.

13. A system according to claim 10, wherein the reporting means secures access to a report whereby the report can only be accessed by an individual, one or more groupings of individuals, or any combination thereof.

14. A system for managing access in respect of a plurality of sites, the system comprising:
identification means for identifying an individual requesting access to a site selected from the plurality of sites whereby access to the site is allowed only when one or more access conditions are satisfied;
computer program and database for determining the access condition based on the site and the identity of the individual, and whether the access condition is satisfied by the individual;
a user interface for providing information to the individual if the access condition is unsatisfied, the information pertaining to the unsatisfied access condition, and for allowing the individual to enter an acknowledgement that the information has been understood;
wherein entry of the acknowledgement is taken to satisfy, at least in part, the unsatisfied access condition.

15. A system according to claim 14, wherein at least one of the access condition or the information relate to occupational health and safety.

16. A system according to claim 14, wherein the individual is allocated by the computer program to one or more groupings of individuals in the database, and the access condition is also determined based on the grouping of individuals to which the individual is allocated.

17. A system according to claim 14, wherein the user interface provides further information to the individual, the further information relating to at least one of the site, the individual or the grouping of individuals to which the individual is allocated.

18. A system according to claim 14, wherein the identification means comprises at least one or more of a security card scanner, biometric scanner, and password.

19. A system according to claim 14, wherein the user interface comprises a touch screen.

20. A system according to claim 14, wherein the system is able to be accessed and configured from any one or more of the plurality of sites.

21. A system according to claim 14, wherein the user interface allows the individual to confirm exit from the site.

22. A system according to claim 14, wherein the computer program determines details of site activity comprising at least one of the number of times the individual has accessed the site or the amount of time the individual has accessed the site for, and the database stores the details of the site activity.

23. A system according to claim 22, wherein the system comprises reporting means for generating reports relating to the site activity of one or more sites.

24. A system according to claim 23, wherein the reports relate to an individual, one or more groupings of individuals, or any combination thereof.

25. A system according to claim 23, wherein the reports relate to one or more selected time periods.

26. A system according to claim 23, wherein the reporting means secures access to a report whereby the report can only be accessed by an individual, one or more groupings of individuals, or any combination thereof.

27. A method for managing access in respect of a plurality of sites, comprising the steps of:
A) identifying an individual requesting access to a site selected from the plurality of sites, the site having one or more access conditions;
B) accessing a database to determine whether the access condition is satisfied by the individual;
C) providing information to the individual via a user interface;
D) receiving an acknowledgement from the individual that the information has been understood wherein the acknowledgement is taken to satisfy, at least in part, the unsatisfied access condition; and
E) allowing access to the site only when the access condition is satisfied.

28. A method according to claim 27, wherein at least one of the access condition or the information relate to occupational health and safety.

29. A method according to claim 27, wherein step A) comprises the sub step of:
accessing the database to determine one or more groupings of individuals to which the individual is allocated;
and step B) comprises the substep of:
i) determining the access condition based on the grouping of individuals to which the individual is allocated;

30. A method according to claim 27, wherein step C) comprises the sub step of:
i) providing further information to the individual via the user interface, the further information relating to at least one of the site, the individual or the grouping of individuals to which the individual is allocated;

31. A method according to claim 27, wherein step A) comprises identifying the individual by one or more of the scanning of a security card, determination of a biometric characteristic of the individual, and the entering of a password.

32. A method according to claim 27, wherein the acknowledgement is entered by the individual via the user interface.

33. A method according to claim 27, wherein the individual confirms exit from the site.

34. A method according to claim 27, wherein the method comprises the additional steps of:
F) determining details of site activity comprising at least one of the number of times the individual has accessed the site or the amount of time the individual has accessed the site for; and
G) storing in the database the details of the site activity.

35. A method according to claim 27, wherein the method comprises the additional step of:
H) accessing the database and generating reports relating to the site activity of one or more sites.

36. A method according to claims 35, wherein step H) comprises the sub step of:
i) securing access to a report whereby the report can only be accessed by an individual, one or more groupings of individuals, or any combination thereof.

37. A method for managing access in respect of a plurality of sites, comprising the steps of:
A) identifying an individual requesting access to a site selected from the plurality of sites;
B) determining one or more access conditions for the site based on the site and the identity of the individual;
C) accessing a database to determine whether the access condition is satisfied by the individual;
D) if the access condition is unsatisfied, providing information to the individual via a user interface, the information pertaining to the unsatisfied access condition;
E) receiving an acknowledgement from the individual that the information has been understood wherein the acknowledgement is taken to satisfy, at least in part, the unsatisfied access condition; and
F) allowing access to the site only when the access condition is satisfied.

38. A method according to claim 37, wherein at least one of the access condition or the information relate to occupational health and safety.

39. A method according to claim 37, wherein step A) comprises the sub step of:
i) accessing the database to determine one or more groupings of individuals to which the individual is allocated;
and step B) comprises the substep of:
i) determining the access condition based on the grouping of individuals to which the individual is allocated;

40. A method according to claim 37, wherein step D) comprises the sub step of:
i) providing further information to the individual via the user interface, the further information relating to at least one of the site, the individual or the grouping of individuals to which the individual is allocated;

41. A method according to claim 37, wherein step A) comprises identifying the individual by one or more of the scanning of a security card, determination of a biometric characteristic of the individual, and the entering of a password.

42. A method according to claim 37, wherein the acknowledgement is entered by the individual via the user interface.

43. A method according to claim 37, wherein the individual confirms exit from the site.

44. A method according to claim 37, wherein the method comprises the additional steps of:
G) determining details of site activity comprising at least one of the number of times the individual has accessed the site or the amount of time the individual has accessed the site for; and
H) storing in the database the details of the site activity.

45. A method according to claim 37, wherein the method comprises the additional step of:
I) accessing the database and generating reports relating to the site activity of one or more sites.

46. A method according to claims 45, wherein step I) comprises the sub step of:
i) securing access to a report whereby the report can only be accessed by an individual, one or more groupings of individuals, or any combination thereof.
